(19) United States
(12) Patent Application Publication
(10) Pub. No.: US 2016/0293286 A1
(43) Pub. Date: Oct. 6, 2016

(54) CONDUCTIVE COMPLEX AND METHOD OF MANUFACTURING THE SAME, AND ELECTRONIC DEVICE INCLUDING THE CONDUCTIVE COMPLEX

(71) Applicant: SAMSUNG ELECTRONICS CO., LTD., Suwon-si (KR)

(72) Inventors: Hiesang SOHN, Seoul (KR); Weonho SHIN, Cheonggyesan-ro (KR); Se Yun KIM, Seoul (KR); Sungwoo HWANG, Seoul (KR); Hee Jung PARK, Daejeon (KR); Jongmin LEE, Hwaseong-si (KR)

(21) Appl. No.: 14/868,651

(22) Filed: Sep. 29, 2015

(30) Foreign Application Priority Data
Apr. 1, 2015 (KR) 10-2015-0046220

(51) Int. Cl. H01B 1/02; C09D 11/52; H01B 13/00; H01B 3/10

(52) U.S. Cl. CPC H01B 1/02; H01B 3/10; C09D 11/52; H01B 13/0026

(57) ABSTRACT

A conductive complex includes a conductive nanobody network including a plurality of conductive nanobodies randomly arranged, and an overcoat layer including zero-dimensionally, one-dimensionally or two-dimensionally shaped non-conductive nanobodies covering the conductive nanobody network. A method of manufacturing the same and an electronic device including the conductive complex are also disclosed.

### CROSS-REFERENCE TO RELATED APPLICATION

This application claims priority to and the benefit of Korean Patent Application No. 10-2015-0046220 filed in the Korean Intellectual Property Office on Apr. 1, 2015, and all the benefits accruing therefrom under 35 U.S.C. §119, the entire contents of which are incorporated herein by reference.

### BACKGROUND

1. Field

A conductive complex, a method of manufacturing the same, and an electronic device are disclosed.

2. Description of the Related Art

Electronic devices such as a liquid crystal display (LCD), an organic light emitting diode (OLED) device, and a touch screen panel (TSP) include a transparent conductor as a transparent electrode.

The transparent conductor may be classified according to materials used. For example, there are organic material-based transparent conductors such as a conductive polymer, oxide-based transparent conductors such as indium tin oxide (ITO), and metal-based transparent conductors.

However, the conductive polymer has high specific resistance and low transparency and may be easily deteriorated when exposed to moisture and air. The ITO may increase the manufacturing cost due to the expensive indium, which is an essential element, and may deteriorate flexibility to limit application for a flexible device. The metal-based transparent conductor may increase the manufacturing cost due to a complicated manufacturing process.

Recently, as flexible devices have drawn attention, a material applicable to a transparent electrode for the flexible device, for example, a metal nanobody such as a silver nanowire, has been researched. The metal nanobody may be, for example, manufactured into a film by preparing an ink composition and then coating and drying the ink composition.

However, the metal nanobody may react with oxygen, sulfur, moisture, and/or the like in air and may deteriorate electrical/optical properties.

### SUMMARY

Disclosed herein is a conductive complex capable of increasing reliability by preventing deterioration of electrical/optical properties over time.

Also disclosed is a method of manufacturing the conductive complex.

Yet another embodiment provides an electronic device including the conductive complex.

According to an embodiment, a conductive complex includes a conductive nanobody network including a plurality of conductive nanobodies randomly arranged and an overcoat layer including zero-dimensionally, one-dimensionally or two-dimensionally shaped non-conductive nanobodies covering at least a portion of the conductive nanobody network.

The non-conductive nanobodies may include a nanowire, a nanotube, a nanoparticle, a nanocapsule, a nanosheet, a nanoplate, a nanocube, a nanosphere, nanosheet, a nanoflake, or a combination thereof.

The non-conductive nanobodies may include an oxide nanowire, an oxide nanotube, an oxide nanoparticle, an oxide nanocapsule, an oxide nanoplate, an oxide nanocube, an oxide nanosphere, oxide nanotube, an oxide nanosheet, an oxide nanoflake, or a combination thereof.

The non-conductive nanobodies may include a semiconductor or insulation material having an energy band gap of about 2.5 eV or more.

The non-conductive nanobodies may include titanium oxide, zinc oxide, aluminum oxide, zirconium oxide, yttrium oxide, chromium oxide, tin oxide, lead oxide, hafnium oxide, hafnium silicate, lanthanum oxide, lanthanum aluminate, lead titanate, tantalum oxide, gallium oxide, gadolinium oxide, tungsten oxide, strontium titanate, barium titanate, iron titanate, potassium titanate, manganese titanate, bismuth oxide, silicon nitride, zinc sulfide, magnesium selenide, magnesium telluride, aluminum nitride, gallium nitride, an alloy thereof, or a combination thereof.

At least two non-conductive nanobodies positioned to be adjacent to each other may have an overlapping portion.

The conductive nanobodies may include a nanowire, a nanotube, a nanoparticle, a nanocapsule, a nanosheet, a nanoplate, a nanocube, a nanosphere, a metal mesh, a metal nano thin film, a metal flake, graphene, or a combination thereof.

The conductive nanobodies may be one-dimensionally shaped nanobodies, and the non-conductive nanobodies may be two-dimensionally shaped nanobodies.

The conductive nanobody network covered by the non-conductive nanobodies may have a surface coverage of greater than or equal to about 15%.

The conductive complex may have both a sheet resistance of less than or equal to about 1000 ohms per square (Ω/sq.) and a light transmittance of greater than or equal to about 70%.

The conductive complex may have a sheet resistance variation ratio, a haze variation ratio, and a light transmittance variation ratio of less than or equal to about 15% after being allowed to stand for 30 days at room temperature.

The conductive complex may further include a substrate, wherein the conductive nanobody network is disposed on the substrate.

According to another embodiment, a method of manufacturing a conductive complex includes applying a conductive ink including a plurality of conductive nanobodies to form a conductive nanobody network and applying a non-conductive ink including zero-dimensionally, one-dimensionally or two-dimensionally shaped non-conductive nanobodies on the conductive nanobody network to form an overcoat layer.

The non-conductive nanobodies may include a nanosheet, a nanoflake, or a combination thereof.

The non-conductive nanobodies may include a semiconductor or insulation material having an energy band gap of about 2.5 eV or more.

The non-conductive nanobodies may include titanium oxide, zinc oxide, aluminum oxide, zirconium oxide, yttrium oxide, chromium oxide, tin oxide, lead oxide, hafnium oxide, hafnium silicate, lanthanum oxide, lanthanum aluminate, lead titanate, tantalum oxide, gallium oxide, gadolinium oxide, tungsten oxide, strontium titanate, barium titanate, iron titanate, potassium titanate, manganese titanate, bismuth oxide, silicon nitride, zinc sulfide, magnesium selenide, magnesium telluride, aluminum nitride, gallium nitride, an alloy thereof, or a combination thereof.

The conductive nanobodies may be one-dimensionally shaped nanobodies, and the non-conductive nanobodies may be two-dimensionally shaped nanobodies.

According to another embodiment, an electronic device including the conductive complex is provided.

The electronic device may be a liquid crystal display, an organic light emitting diode display, a touch screen panel, a solar cell, a photoelectric device, or a sensor.

### BRIEF DESCRIPTION OF THE DRAWINGS

The above and other aspects, advantages and features will become more apparent by describing in further detail exemplary embodiments thereof with reference to the accompanying drawings in which:

FIG. 1 is a schematic view showing exemplary embodiment of a conductive complex,

FIG. 2 is a cross-sectional view schematically showing the exemplary conductive complex of FIG. 1,

FIG. 3 is a top plan view schematically showing the exemplary conductive complex of FIG. 1,

FIGS. 4 to 6 are schematic views sequentially showing an exemplary embodiment of a method of manufacturing a conductive complex,

FIG. 7 is a schematic cross-sectional view showing an exemplary embodiment of an organic light emitting diode device,

FIG. 8A is a TEM photograph showing the silver nanowire obtained in Preparation Example 1,

FIG. 8B is a TEM photograph showing the TiO₂ nanosheet obtained in Preparation Example 2,

FIG. 8C is a TEM photograph of the conductive complex according to Example 1,

FIG. 9A is a SEM photograph showing the silver nanowire obtained in Preparation Example 1,

FIG. 9B is a SEM photograph showing the TiO₂ nanosheet obtained in Preparation Example 2.

FIG. 9C is a SEM photograph showing the conductive complex according to Example 1,

FIG. 10 is a photograph showing the conductive complex according to Example 1,

FIGS. 11A and 11B are SEM photographs showing the conductive complex according to Example 1 before being exposed to air and after being exposed to air for 30 days, respectively,

FIGS. 12A and 12B are SEM photographs showing a conductive complex according to Example 2 before being exposed to air and after being exposed to air for 30 days, respectively,

FIGS. 13A and 13B are SEM photographs showing the conductive complex according to Comparative Example 1 before being exposed to air and after being exposed to air for 30 days, respectively,

FIGS. 14A and 14B are each Comparative SEM photographs showing the conductive complex according to Example 2 before being exposed to air and after being exposed to air for 30 days, respectively,

FIG. 15A shows surface atomic analysis results of the conductive complex according to Example 1,

FIG. 15B shows surface atomic analysis results of the conductive complex according to Example 1 after being exposed to air for 30 days,

FIG. 16A shows surface atomic analysis results of the conductive complex according to Example 2,

FIG. 16B shows surface atomic analysis results of the conductive complex according to Example 2 after being exposed to air for 30 days,

FIG. 17A shows surface atomic analysis results of the conductive complex according to Comparative Example 1,

FIG. 17B shows surface atomic analysis results of the conductive complex according to Comparative Example 1 after being exposed to air for 30 days,

FIG. 18A shows surface atomic analysis results of the conductive complex according to Comparative Example 2,

FIG. 18B shows surface atomic analysis results of the conductive complex according to Comparative Example 2 after being exposed to air for 30 days.

FIG. 19 is a graph showing sheet resistance changes of the conductive complex according to Example 1 over time,

FIG. 20 is a graph showing sheet resistance changes of the conductive complex according to Example 2 over time,

FIG. 21 is a graph showing sheet resistance changes of the conductive complex according to Comparative Example 1 over time,

FIG. 22 is a graph showing sheet resistance changes of the conductive complex according to Comparative Example 2 over time,

FIG. 23 is a graph showing light transmittance changes of the conductive complex according to Example 1 over time,

FIG. 24 is a graph showing light transmittance changes of the conductive complex according to Example 2 over time,

FIG. 25 is a graph showing haze changes of the conductive complex according to Example 1 over time,

FIG. 26 is a graph showing haze changes of the conductive complex according to Comparative Example 2 over time, and

FIG. 27 is a graph showing light transmittance depending on surface coverage of the TiO₂ nanosheet of the conductive complex according to Example 1.

### DETAILED DESCRIPTION

Exemplary embodiments will hereinafter be described in detail, and may be easily performed by those who have common knowledge in the related art. However, this disclosure may be embodied in many different forms and is not construed as limited to the exemplary embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the disclosure.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope thereof unless otherwise claimed. No language in the specification should be construed as indicating any non-claimed element as essential to the practice of the embodiments as used herein.

Hereinafter, a conductive complex according to an exemplary embodiment is described.

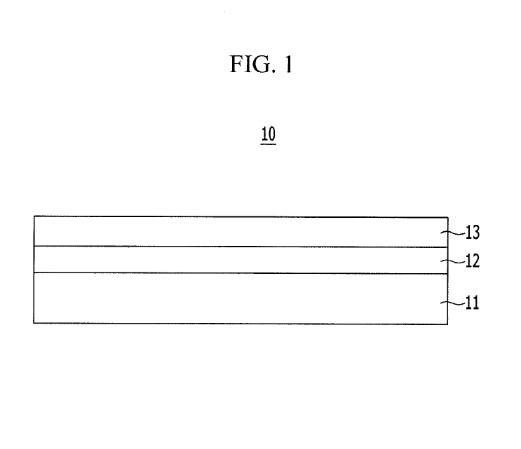

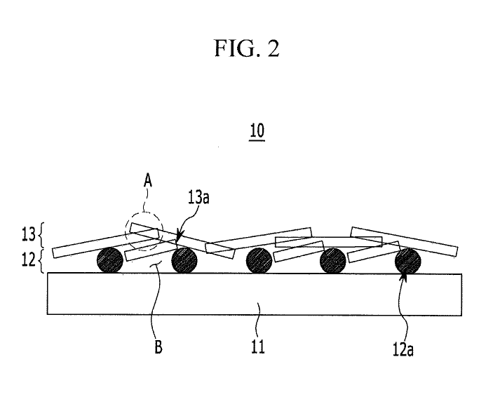

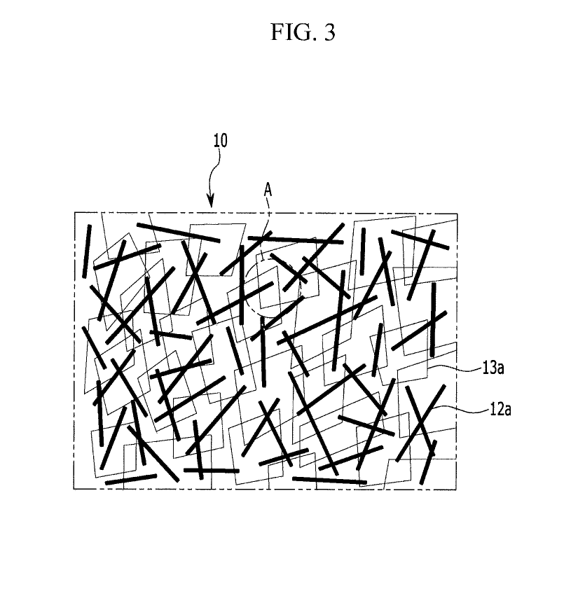

FIG. 1 is a schematic view showing a conductive complex according to an exemplary embodiment, FIG. 2 is a cross-sectional view schematically showing the conductive complex of FIG. 1, and FIG. 3 is a top plan view schematically showing the conductive complex of FIG. 1.

Referring to FIGS. 1 and 2, a conductive complex 10 according to an embodiment includes a substrate 11, a conductive layer 12 including a plurality of conductive nanobodies 12a, and an overcoat layer 13 including a plurality of non-conductive nanobodies 13a.

The substrate 11 may be a glass substrate, a semiconductor substrate, or a polymer substrate. An insulation layer, a semiconductor layer, and/or a conductive layer may be laminated on the glass substrate, the semiconductor substrate, or the polymer substrate. The polymer substrate may be, for example, polyethylene terephthalate, polycarbonate, polyimide, polyethylene naphthalate, a copolymer thereof, or a combination thereof, but is not limited thereto.

The conductive layer 12 includes a conductive nanobody network where a plurality of conductive nanobodies 12a is randomly arranged. The conductive nanobodies 12a are a nano-sized body including a conductive material, and may be zero-dimensionally, one-dimensionally, two-dimensionally, and/or three-dimensionally shaped nanobodies.

The conductive nanobodies 12a may include, for example, nanowires, nanotubes, nanoparticles, nanocapsules, nanosheets, nanoplates, nanocubes, nanospheres, metal meshes, metal nano thin films, metal flakes, graphene, or a combination thereof, but are not limited thereto.

The conductive nanobodies 12a may have, for example, a diameter of less than or equal to about 500 nanometers (nm), specifically, a diameter ranging from about 10 nm to about 500 nm, and more specifically, a diameter ranging from about 20 nm to about 300 nm.

The conductive nanobodies 12a may include, for example, a low resistance metal such as silver (Ag) and/or copper (Cu), and specifically, a nanobody thereof. The conductive nanobodies 12a may be metal nanobodies coated with an organic material produced and/or attached on the surface thereof during synthesis, for example, with polyvinylpyrrolidone (PVP). The conductive nanobodies 12a may be silver nanobodies coated with, for example, PVP.

Referring to FIG. 3, a plurality of the conductive nanobodies 12a may be randomly arranged without specific directionality and may contact one another, and thus have electrical conductivity. The conductive nanobodies may form one or more conductive networks. The one or more conductive networks may be disposed on a substrate.

The overcoat layer 13 may be positioned to neighbor the conductive layer 12 and have contact therewith.

The overcoat layer 13 includes the plurality of non-conductive nanobodies 13a. The non-conductive nanobodies 13a may be zero-dimensionally, one-dimensionally or two-dimensionally shaped nanobodies, for example nanowires, nanotubes, nanosheets, nanoflakes, or a combination thereof. The non-conductive nanobodies 13a may be, for example, nanosheets, nanoflakes, or a combination thereof, and the nanosheets and/or the nanoflakes may have, for example, a thickness of about 500 nm or less, specifically, a thickness ranging from about 0.1 nm to 300 nm, and more specifically, a thickness ranging from about 3 nm to 200 nm.

The non-conductive nanobodies 13a may be, for example, a non-conductive nano-sized body including a non-conductive material such as a semiconductor material and/or an insulation material.

The non-conductive nanobodies 13a may include, for example, oxide nanosheets, oxide nanoflakes, or a combination thereof, and for another example, metal oxide nanosheets, semi-metal oxide nanosheets, metal oxide nanoflakes, semi-metal oxide nanoflakes, or a combination thereof. The non-conductive nanobodies 13a may include, for example, metal-doped oxide nanosheets, metal-doped oxide nanoflakes, or a combination thereof, and for another example, metal-doped metal oxide nanosheets, metal-doped semi-metal oxide nanosheets, metal-doped metal oxide nanoflakes, metal-doped semi-metal oxide nanoflakes, or a combination thereof.

The non-conductive nanobodies 13a may include, for example, a semiconductor or insulation material having an energy band gap of about 2.5 eV or more. Accordingly, the non-conductive nanobodies 13a may prevent catalytic activity of an oxidation and/or a sulfide reaction, and thus effectively protect conductive nanobody network and more effectively prevent deterioration of electrical/optical properties of the conductive complex over time.

The non-conductive nanobodies 13a may include, for example, titanium oxide (TiO₂), zinc oxide (ZnO), aluminum oxide (Al₂O₃), zirconium oxide (ZrO), yttrium oxide (Y₂O₃), chromium oxide (CrO), tin oxide (SnO₂), lead oxide (PbO), hafnium oxide (HfO₂), hafnium silicate (HfSiO₄), lanthanum oxide (La₂O₃), lanthanum aluminate (LaAlO₃), lead titanate (PbTiO₃), tantalum oxide (Ta₂O₅), gallium oxide (Ga₂O₃), gadolinium oxide (Gd₂O₃), tungsten oxide (WO₃), strontium titanate (SrTiO₃), barium titanate (BaTiO₃), iron titanate (FeTiO₃), potassium titanate (KTaO₃), manganese titanate (MnTiO₃), bismuth oxide (Bi₂O₃), silicon nitride (Si₃N₄), zinc sulfide (ZnS), magnesium selenide (MgSe), magnesium telluride (MgTe), aluminum nitride (AlN), gallium nitride (GaN), an alloy thereof, or a combination thereof, but is not limited thereto.

For example, the conductive nanobodies 12a may be one-dimensionally shaped nanobodies arranged randomly, and the non-conductive nanobodies 13a may be two-dimensionally shaped nanobodies. For example, the conductive nanobodies 12a may be a metal nanowire and/or metal nanotube, carbon nanowire and/or carbon nanotube and the non-conductive nanobodies 13a may be an oxide nanosheet and/or an oxide nanoflake. For example, the conductive nanobodies 12a may be a silver nanowire, and the non-conductive nanobodies 13a may be a titanium oxide nanosheet, a zinc oxide nanosheet, a silicon oxide nanosheet, an aluminum oxide nanosheet, a zirconium oxide nanosheet, a yttrium oxide nanosheet, a chromium oxide nanosheet, or a combination thereof.

Referring to FIGS. 2 and 3, at least two non-conductive nanobodies 13a neighboring one another may have a region A where they overlap one another and effectively cover the surface of the conductive layer 12. Accordingly, electrical/optical properties of the conductive complex may be less deteriorated over time by reducing the area of the conductive complex exposed to air and thus the oxidation and/or the sulfide reaction of the conductive nanobodies 12a.

Further as shown in FIGS. 2 and 3, more than two adjacent nanobodies may overlap one another to provide greater surface coverage. For example, the conductive nanobody network covered with the non-conductive nanobodies 13a may have surface coverage of greater than or equal to about 15%. In some embodiments conductive nanobody network covered with the non-conductive nanobodies 13a may have surface coverage of 15% to 100%, or 20% to 100%, or 30% to 100%, or 40% to 100%, or 50% to 100%. Herein, the surface coverage may be defined as the area of the conductive nanobody network covered with the non-conductive nanobodies 13a relative to the entire area of the conductive nanobody network, and may be measured by analyzing an image with an electron microscope, an atomic microscope, a surface analyzer, or the like. When the surface coverage is within the range, the degradation of electrical/optical properties may be more effectively prevented by reducing the area of the conductive nanobodies 12a exposed to air.

Herein, the non-conductive nanobodies 13a cover the conductive nanobody network on top, and may form a gap (B) as shown in FIG. 2 among a plurality of conductive nanobodies 12a and between the conductive nanobodies 12a and the non-conductive nanobodies 13a.

The conductive complex 10 may further include a protective layer (not shown) covering the overcoat layer 13. The protective layer may include, for example, an organic material, an inorganic material, or an organic/inorganic material.

As stated above, the conductive complex may have both a sheet resistance of less than or equal to about 1000 ohms per square and a light transmittance of greater than or equal to about 70%. In other embodiments, the conductive complex 10 may be, for example, a transparent conductive complex, and may simultaneously have a haze of less than or equal to about 2.5, a light transmittance of greater than or equal to about 70%, and a sheet resistance of less than or equal to about 1000 ohms per square (Ω/sq.) Within the ranges, the haze may range, for example, from about 0.5 to about 1.4, or, for example, from about 0.7 to about 1.3. Within the ranges, the light transmittance may range, for example, from about 85 to about 100%, or, for example, from about 88% to about 100%. Within the ranges, the sheet resistance may range, for example, from about 20 to about 200 Ω/sq., or, for example, from about 30 to about 90 Ω/sq. When the haze is within the range, the conductive complex 10 simultaneously satisfies light transmittance and sheet resistance, and thus may be usefully applied as a transparent electrode.

As described above, the conductive complex may reduce the exposure of the conductive nanobodies such as metal nanobodies to air and thus degradation of the electrical/optical properties of the conductive complex over time. For example, the conductive complex may have each of a sheet resistance variation ratio, a haze variation ratio, and a light transmittance variation ratio of less than or equal to about 10%, for example about 5%, after being allowed to stand for 30 days at room temperature.

Hereinafter, a method of manufacturing the conductive complex is described.

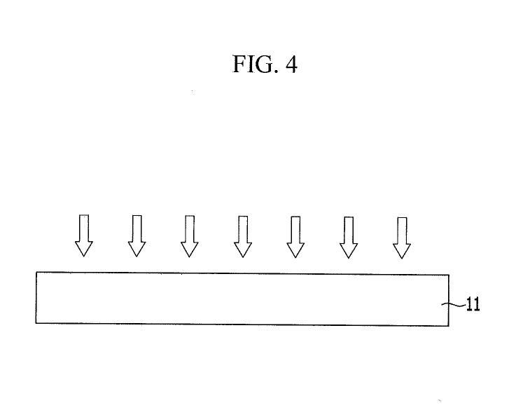

FIGS. 4 to 6 are schematic views sequentially showing a method of manufacturing a conductive complex according to one embodiment.

First, a conductive ink including the conductive nanobodies 12a is prepared.

The conductive ink may include, for example, the conductive nanobodies 12a, a binder, and a solvent.

The conductive nanobodies 12a may be nano-sized bodies including a conductive material, and may be one-dimensionally, two-dimensionally, and/or three-dimensionally shaped nanobodies, for example a nanowire, a nanotube, a nanoparticle, a nanocapsule, a nanosheet, a nanoplate, a nanocube, a nanosphere, a metal mesh, a metal nano thin film, a metal flake, graphene, or a combination thereof, but are not limited thereto.

The conductive nanobodies 12a may include a low resistance metal such as silver (Ag) and/or copper (Cu), and for example, a silver nanobody. The conductive nanobodies 12a may be synthesized by a variety of methods known in the art. In an embodiment, the conductive nanobodies may be synthesized by the “polyol method”, which may include dissolving and reducing a metal compound in a polyol such as glycol under a predetermined condition, optionally in the presence of a protective polymer, for example, polyvinylpyrrolidone (PVP). Accordingly, the synthesized conductive nanobodies may include an organic material on the surface of a nanobody formed of a metal. For example, the conductive nanobodies 12a may be a metal nanobody coated with a polymer, for example, a metal nanobody coated with PVP. For example, the conductive nanobodies 12a may be a silver (Ag) nanobody coated with a polymer, and more specifically, a silver nanobody coated with PVP.

The conductive nanobodies 12a may be included in an amount of about 0.01 to 20 wt % based on the entire amount of the conductive ink.

The binder may be any material capable of appropriately adjusting viscosity of the conductive ink and increasing bonding strength of the metal nanobody on a substrate without a particular limit. The binder may be, for example an organic binder, for example methyl cellulose, ethyl cellulose, hydroxypropyl methylcellulose (HPMC), hydroxypropyl cellulose (HPC), xanthan gum, polyvinyl alcohol (PVA), polyvinylpyrrolidone (PVP), carboxy methyl cellulose, hydroxyl ethyl cellulose, or a combination thereof, but is not limited thereto.

The binder may be included in an amount of about 5 to about 50, or about 10 to about 30, parts by weight based on 100 parts by weight of the metal nanobody.

The conductive ink may optionally further include a polymer dispersing agent. The polymer dispersing agent may be a polymer having a weight average molecular weight of less than or equal to about 40,000 g/mole, for example, a (meth)acrylate compound. When the weight average molecular weight is within the range, the polymer dispersing agent may prevent sheet resistance and haze increases. The polymer dispersing agent may be included in an amount of about 0.1 to 5 parts by weight based on 100 parts by weight of the conductive nanobody.

The solvent may include a medium in which the conductive nanobodies 12a and the binder are dissolved and/or dispersed. The solvent may be, for example, water. The solvent may be, for example, a mixture of water and alcohol, wherein the alcohol may be, for example, methanol, ethanol, n-propyl alcohol, isopropyl alcohol, n-butanol, isobutanol, t-butanol, propylene glycol, propylene glycolmethylether, ethylene glycol, or a combination thereof. The solvent may be included in a balance amount other than the components and other solids.

A non-conductive ink including the non-conductive nanobodies 13a is prepared.

The non-conductive ink may include, for example, the non-conductive nanobodies 13a, the binder, the solvent, and optionally a polymer dispersing agent.

The non-conductive nanobodies 13a may be zero-dimensionally, one-dimensionally or two-dimensionally shaped nanobodies, for example nanoparticles, nanospheres, nanowires, nanotubes, nanosheets, nanoflakes, nanoplates, or a combination thereof. The non-conductive nanobodies 13a may be, for example, non-nano-sized bodies including a non-conductive material such as a semiconductor material and/or an insulation material. For example, the non-conductive nanobodies 13a may include, for example, a semiconductor or insulation material having an energy band gap of about 2.5 eV or more.

For example, the non-conductive nanobodies 13a may be a material being soluble or dispersible in water and/or an organic solvent.

The non-conductive nanobodies 13a may include, for example, titanium oxide (TiO₂), zinc oxide (ZnO), aluminum oxide (Al₂O₃), zirconium oxide (ZrO), yttrium oxide (Y₂O₃), chromium oxide (CrO), tin oxide (SnO₂), lead oxide (PbO), hafnium oxide (HfO₂), hafnium silicate (HfSiO₄), lanthanum oxide (La₂O₃), lanthanum aluminate (LaAlO₃), lead titanate (PbTiO₃), tantalum oxide (Ta₂O₅), gallium oxide (Ga₂O₃), gadolinium oxide (Gd₂O₃), tungsten oxide (WO₃), strontium titanate (SrTiO₃), barium titanate (BaTiO₃), iron titanate (FeTiO₃), potassium titanate (KTaO₃), manganese titanate (MnTiO₃), bismuth oxide (Bi₂O₃), silicon nitride (Si₃N₄), zinc sulfide (ZnS), magnesium selenide (MgSe), magnesium telluride (MgTe), aluminum nitride (AlN), gallium nitride (GaN), an alloy thereof, or a combination thereof, but is not limited thereto.

The binder, the polymer dispersing agent, and the solvent are the same as described above.

Referring to FIG. 4, the surface of a substrate 11 is pre-treated. The pre-treatment may be, for example, a plasma treatment or a corona treatment but is not limited thereto. The pre-treatment may make the surface of the substrate 11 strongly hydrophilic and thus closely and/or strongly adhere conductive nanobodies and/or non-conductive nanobodies on the substrate 11 without being detached therefrom. The pre-treatment may be omitted as necessary.

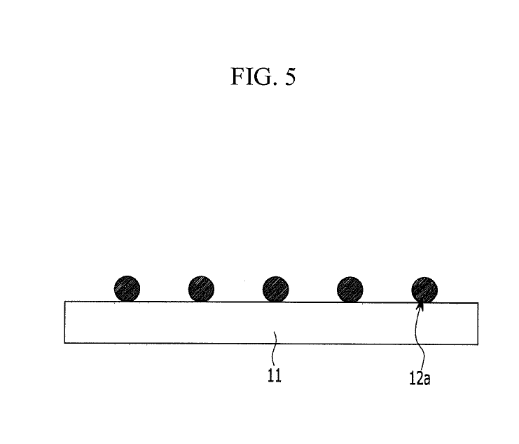

Referring to the following FIG. 5, the conductive ink including the conductive nanobodies 12a is applied on the substrate 11. The conductive ink may be applied using a solution process, and may be, for example, applied using slit coating, bar coating, blade coating, slot die coating, inkjet coating, dip coating, or a combination thereof, without limitation.

Subsequently, the applied conductive ink is dried to form the conductive layer 12 including a plurality of the conductive nanobodies 12a. The conductive layer 12 may form a conductive nanobody network in which a plurality of the conductive nanobodies 12a are randomly arranged. The drying may include natural drying, hot air drying, and/or a heat treatment at a higher temperature than the boiling point of the aforementioned solvent.

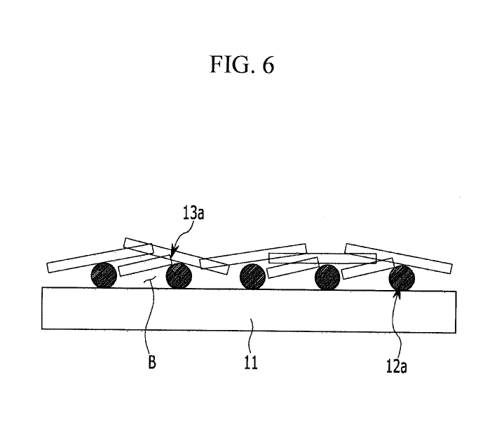

Referring to FIG. 6, a non-conductive ink including the non-conductive nanobodies 13a is applied on the conductive layer 12. The non-conductive ink may be applied using various methods, for example slit coating, bar coating, blade coating, slot die coating, inkjet coating, dip coating, or a combination thereof, without limitation.

Subsequently, the applied non-conductive ink is dried, forming an overcoat layer 13 covering the conductive layer 12. The drying may be natural drying, hot air drying, and/or a heat treatment at a higher temperature than the boiling point of the aforementioned solvent.

The overcoat layer 13 may include the binder and optionally the polymer dispersing agent in addition to the non-conductive nanobodies 13a. As shown in FIGS. 2 and 3, the non-conductive nanobodies 13a cover the conductive layer 12 and may have an overlapping portion with neighboring non-conductive nanobodies 13a.

For example, the conductive nanobodies 12a may be one-dimensionally shaped nanobodies arranged randomly, and the non-conductive nanobodies 13a may be two-dimensionally shaped nanobodies. For example, the conductive nanobodies 12a may be a metal nanowire and/or metal nanotube, and the non-conductive nanobodies 13a may be an oxide nanosheet and/or an oxide nanoflake. For example, the conductive nanobodies 12a may be a silver nanowire, and the non-conductive nanobodies 13a may be a titanium oxide nanosheet, a zinc oxide nanosheet, a silicon oxide nanosheet, an aluminum oxide nanosheet, a zirconium oxide nanosheet, a yttrium oxide nanosheet, a chromium oxide nanosheet, or a combination thereof.

In this way, the conductive nanobodies 12a and the non-conductive nanobodies 13a may be applied through a relatively simple solution process, and thus may have a simplified process and a reduced manufacturing cost.

Subsequently, a protective layer (not shown) covering the overcoat layer 13 may be selectively further formed. The protective layer may also be coated through a solution process, but the present invention is not limited thereto.

The conductive complex may be, for example, a transparent conductive complex, and may be applied to a transparent electrode for various electronic devices. The electronic device may be, for example, a flat panel display such as a liquid crystal display (LCD) and an organic light emitting diode (OLED) device, a touch screen panel (TSP); a solar cell, an e-window, a heat mirror, or a transparent transistor, but is not limited thereto. In addition, as the transparent conductive complex is a thin film including the nanobodies and has sufficient flexibility, it may be usefully applied to a flexible electronic device.

Hereinafter, as one example of the electronic device, an organic light emitting diode device in which the conductive complex is applied to a transparent electrode is described with reference to the drawings.

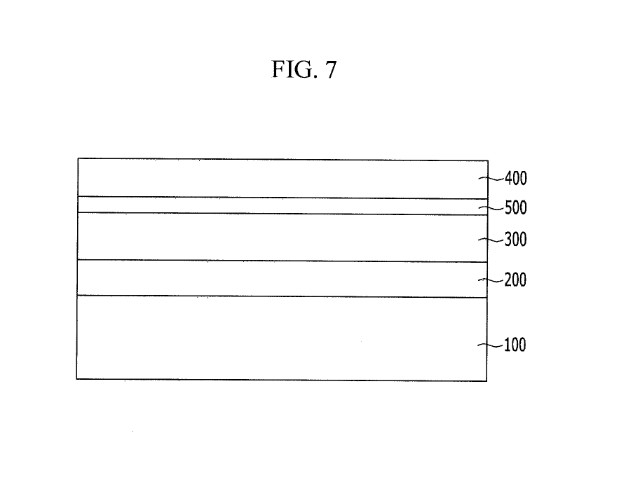

FIG. 7 is a schematic cross-sectional view showing an exemplary embodiment of an organic light emitting diode device according to one embodiment.

Referring to FIG. 7, the exemplary organic light emitting diode device includes a substrate 100, a lower electrode 200, an upper electrode 400 facing the lower electrode 200, and an emission layer 300 interposed between the lower electrode 200 and the upper electrode 400.

The substrate 100 may be, for example, a glass substrate, a polymer substrate, or a silicon substrate. The polymer substrate may be, for example, polycarbonate, polymethylmethacrylate, polyethylene terephthalate, polyethylene naphthalate, polyimide, polyethersulfone, or a combination thereof. The polymer substrate may be useful for a flexible device.

One of the lower electrode 200 and the upper electrode 400 is a cathode, and the other is an anode. For example, the lower electrode 200 may be an anode, and the upper electrode 400 may be a cathode.

At least one of the lower electrode 200 and the upper electrode 400 is transparent. When the lower electrode 100 is transparent, an organic light emitting diode device may have bottom emission in which light is emitted toward the substrate 100, while when the upper electrode 400 is transparent, the organic light emitting diode device may have top emission in which light is emitted opposite the substrate 100. In addition, when the lower electrode 200 and upper electrode 400 are both transparent, light may be emitted both toward the substrate 100 and opposite the substrate 100.

The transparent electrode may be the conductive complex details of which are the same as above.

The emission layer 300 may be made of an organic material emitting one light among primary colors such as red, green, blue, and the like, or a mixture of an inorganic material with the organic material, for example, a polyfluorene derivative, a (poly)paraphenylenevinylene derivative, a polyphenylene derivative, a polyfluorene derivative, polyvinylcarbazole, a polythiophene derivative, or a compound prepared by doping these polymer materials with a perylene-based pigment, a coumarin-based pigment, a rothermine-based pigment, rubrene, perylene, 9,10-diphenylanthracene, tetraphenylbutadiene, Nile red, coumarin, quinacridone, and the like. An organic light emitting diode device displays a desirable image by a spatial combination of primary colors emitted by an emission layer therein.

The emission layer 300 may emit white light by combining three primary colors such as red, green, and blue. Specifically, the emission layer 300 may emit white light by combining colors of neighboring sub-pixels or by combining laminated colors in a vertical direction.

An auxiliary layer 500 may be positioned between the emission layer 300 and the upper electrode 400 to improve luminous efficiency. In the drawing, the auxiliary layer 500 is shown only between the emission layer 300 and the upper electrode 400, but is not limited thereto, and may be positioned between and emission layer 300 and the lower electrode 200, or may be positioned between the emission layer 300 and the upper electrode 400 and between the emission layer 300 and the lower electrode 200.

The auxiliary layer 500 may include an electron transport layer (ETL) and a hole transport layer (HTL) for balancing between electrons and holes, an electron injection layer (EIL) and a hole injection layer (HIL) for reinforcing injection of electrons and holes, and the like. It may include one or more layers selected therefrom. The auxiliary layer 500 may be omitted.

The case in which the conductive complex is applied to an organic light emitting diode device is described herein, but it is not limited thereto. It may be used for an electrode for all electronic devices using a transparent electrode. For example, it may be applied to a pixel electrode and/or a common electrode of a liquid crystal display (LCD), a display electrode of a plasma display device, a transparent electrode of a touch screen panel device, a transparent electrode of a solar cell, a transparent electrode of a photoelectronic device, a transparent electrode of a sensor, and the like.

Hereinafter, the embodiments are illustrated in more detail with reference to examples. These examples, however, are not in any sense to be interpreted as limiting the scope of this disclosure.

### Preparation of Conductive Ink

### Preparation Example 1

10 ml of a AgNO₃ solution (0.1 M, in ethylene glycol) is put in a flask and heated to 160° C. Subsequently, 1 mL of NaCl is quickly added to the solution, the mixture is reacted for 15 minutes, and then a polyvinylpyrrolidone solution (0.15 M, in ethylene glycol) is injected therein drop by drop for 10 minutes. The obtained mixture is maintained at 160° C. for 2 hours and cooled down to room temperature (about 25° C.). The solution is diluted with acetone and centrifuged at 4000 rpm for 30 minutes, and then a supernatant is removed therefrom. Subsequently, water is added to the centrifuge tube, and the mixture is centrifuged again. A supernatant is then removed therefrom again, and this process is repeated twice more, synthesizing silver nanowires (Ag nanowires).

Subsequently, a silver nanowire solution including 0.384 g of an aqueous solution including the synthesized silver nanowire, 0.5 g of a 0.25 wt % hydroxypropyl methylcellulose (HPMC) (H7509, Sigma-Aldrich Co., Ltd.) aqueous solution, and water and isopropyl alcohol (at a wt/wt ratio of 79.2:21.8) is prepared.

### Preparation of Non-Conductive Ink

### Preparation Example 2

H_{1.07}Ti_{1.73}O₄.H₂O in an acid-exchanged form is obtained by adding a HCl solution to potassium lithium titanate (K_{0.8}[Ti_{1.73}Li_{0.27}]O₄) grown through melt and recrystallization according to a flux melt method. Subsequently, a TiO₂ nanosheet is obtained by deintercalating the H_{1.07}Ti_{1.73}O₄.H₂O with an aqueous tetrabutyl ammonium hydroxide solution.

A TiO₂ nanosheet solution including 3.06 g of an aqueous solution including the TiO₂ nanosheet, 0.8 g of a 0.25 wt % hydroxypropyl methylcellulose (HPMC) (H7509, Sigma-Aldrich Co., Ltd.) aqueous solution, 2 g of water, and 0.29 g of isopropyl alcohol is then prepared.

### Preparation Example 3

0.2 g of hexamethylene tetramine (HMT) and 0.2 g of Zn(NO₃)₂.6H₂O are added to 200 ml of ethanol, and the mixture is agitated in an oven. Subsequently, the mixture is centrifuged at 6000 rpm for 2 minutes and washed several times, and redispersed into ethanol, obtaining a ZnO nanosheet.

A ZnO nanosheet solution including 3.06 g of an aqueous solution including the ZnO nanosheet, 0.8 g of a 0.25 wt % hydroxypropyl methylcellulose (HPMC) (H7509, Sigma-Aldrich Co., Ltd.) aqueous solution, 2 g of water, and 0.29 g of isopropyl alcohol is then prepared.

### Manufacture of Conductive Complex

### Example 1

The surface of a polycarbonate substrate is pre-treated with plasma (3% O₂/Ar) and modified. Subsequently, the silver nanowire solution according to Preparation Example 1 is bar-coated on the surface-modified substrate and then dried at 80° C., forming a conductive layer. The TiO₂ nanosheet solution according to Preparation Example 2 is then bar-coated on the conductive layer and dried at 80° C. to form an overcoat layer, resulting in a conductive complex.

### Example 2

A conductive complex is manufactured according to the same method as Example 1, except for using the ZnO nanosheet solution according to Preparation Example 3 instead of the TiO₂ nanosheet solution according to Preparation Example 2.

### Comparative Example 1

A conductive complex is manufactured according to the same method as Example 1, except for not forming an overcoat layer.

### Comparative Example 2

The surface of a polycarbonate substrate is pre-treated with plasma (3% O₂/Ar) and is thus surface-modified. Subsequently, the TiO₂ nanosheet solution according to Preparation Example 2 is bar-coated on the surface-modified substrate and then dried at 80° C., forming a conductive layer. The silver nanowire solution according to Preparation Example 1 is then bar-coated on the conductive layer and then dried at 80° C. to from an overcoat layer, resulting in a conductive complex.

### Evaluation 1: Confirmation of Conductive Complex

The conductive complex according to Example 1 is confirmed.

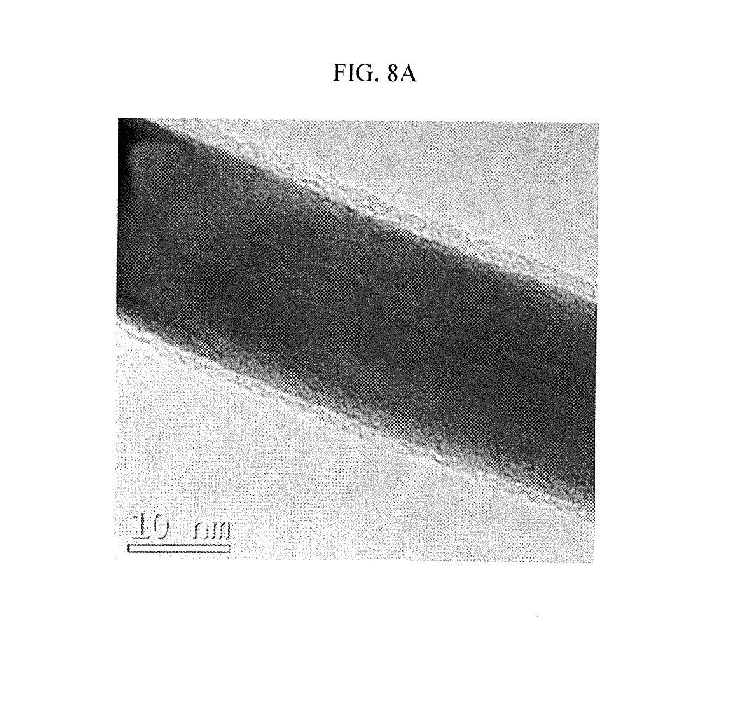

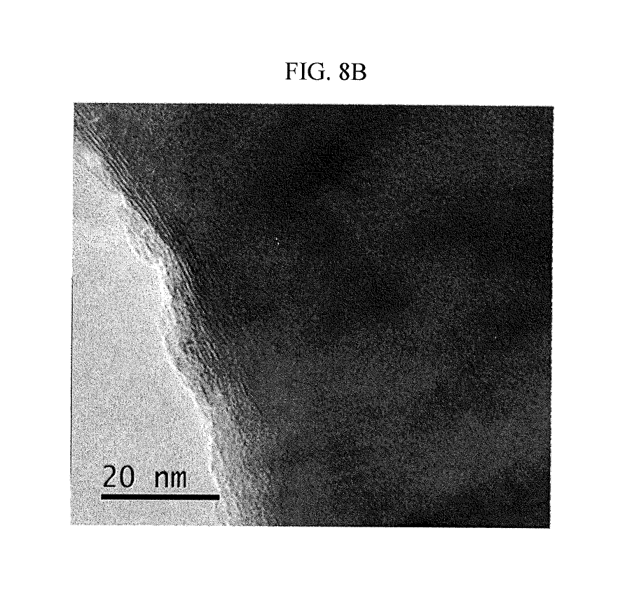

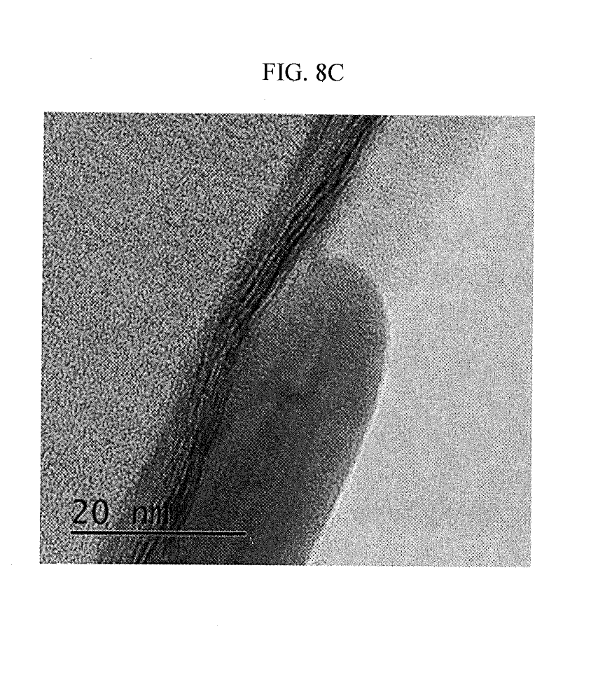

FIG. 8A is a transmission electron microscope (TEM) photograph showing the silver nanowire obtained in Preparation Example 1, FIG. 8B is a TEM photograph showing the TiO₂ nanosheet obtained in Preparation Example 2, and FIG. 8C is a TEM photograph showing the conductive complex according to Example 1.

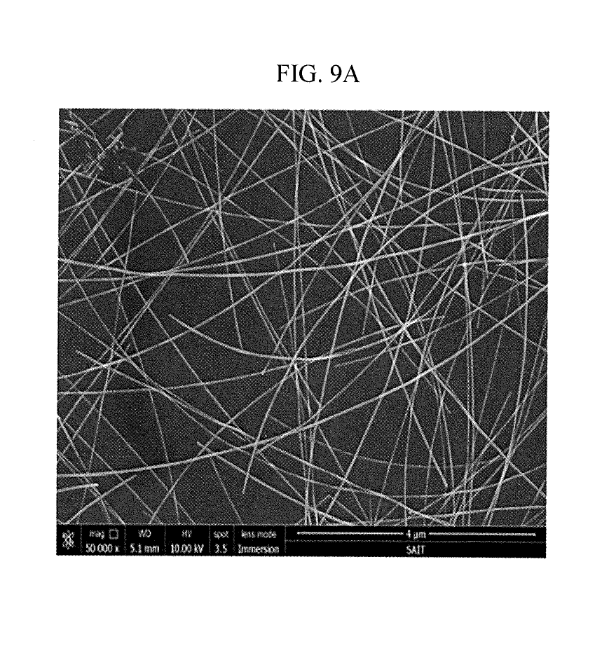

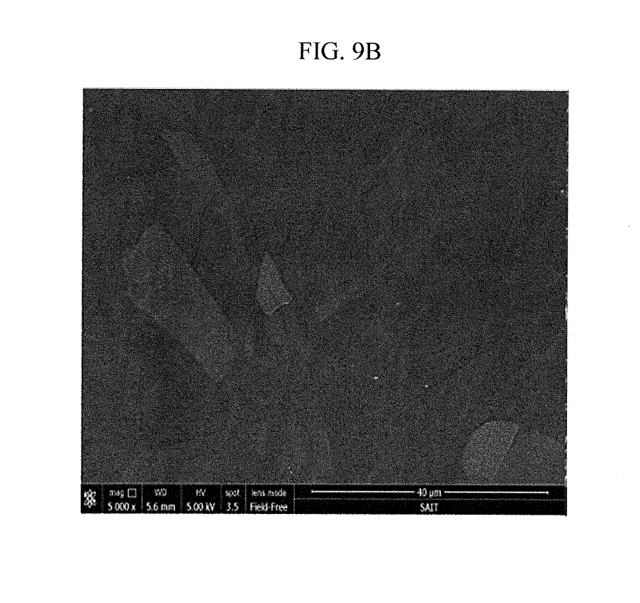

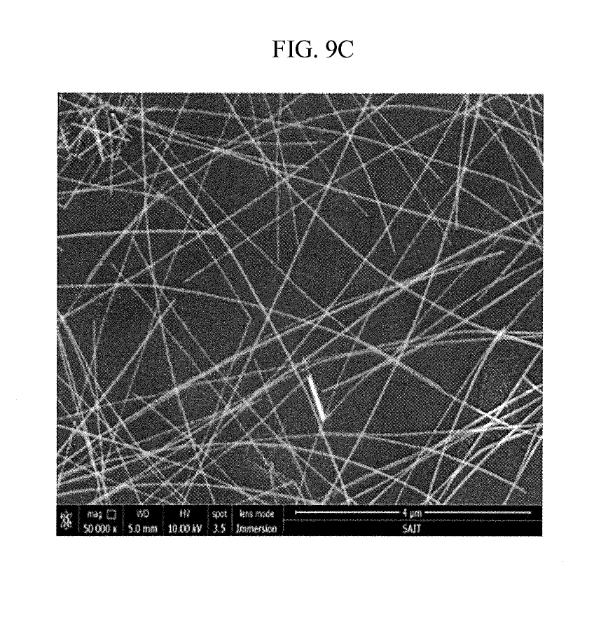

FIG. 9A is a scanning electron microscope (SEM) photograph showing the silver nanowire obtained in Preparation Example 1, FIG. 9B is a SEM photograph showing the TiO₂ nanosheet obtained in Preparation Example 2, and FIG. 9C is a SEM photograph showing the conductive complex according to Example 1.

Referring to FIGS. 8C and 9C, a two-dimensional TiO₂ nanosheet covers the silver nanowire network including a one-dimensional silver nanowire in the conductive complex according to Example 1.

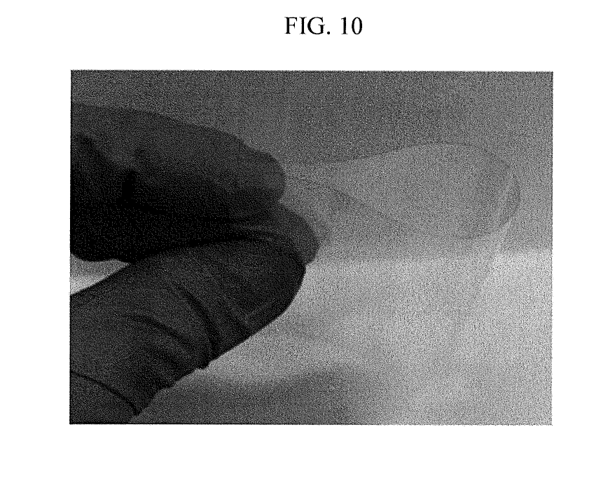

FIG. 10 is a photograph showing the conductive complex according to Example 1.

Referring to FIG. 10, the conductive complex according to Example 1 satisfies transparency and flexibility.

### Evaluation 2: Chemical Stability Change Over Time

Chemical stability of each conductive complex according to Examples 1 and 2 and Comparative Examples 1 and 2 over time is evaluated.

The chemical stability is evaluated by exposing each conductive complex according to Examples 1 and 2 and Comparative Examples 1 and 2 to air for 30 days, and comparing its surface morphology and surface atomic analysis changes before and after the exposure. The surface morphology is obtained by using a SEM, and the surface atomic analysis is performed by using SEM-EDS (energy dispersive spectroscopy).

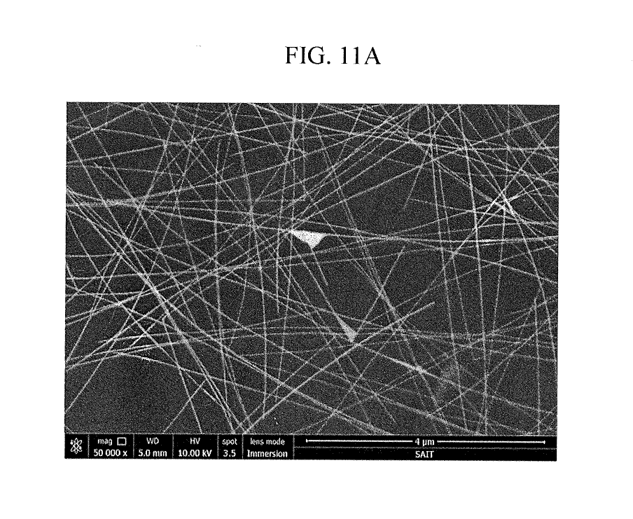

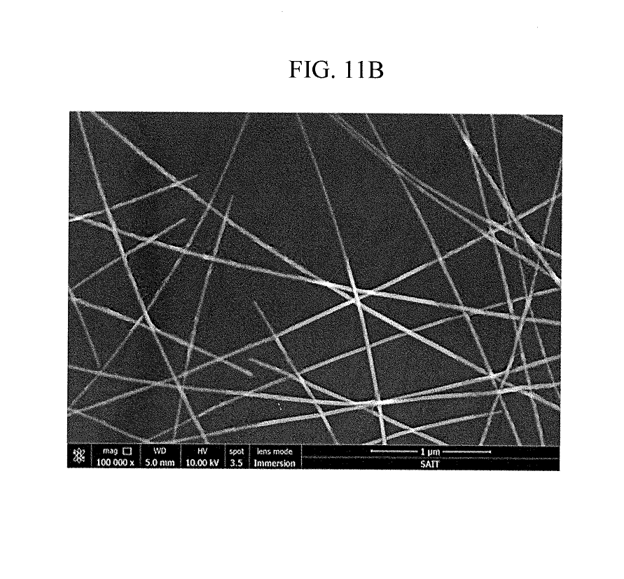

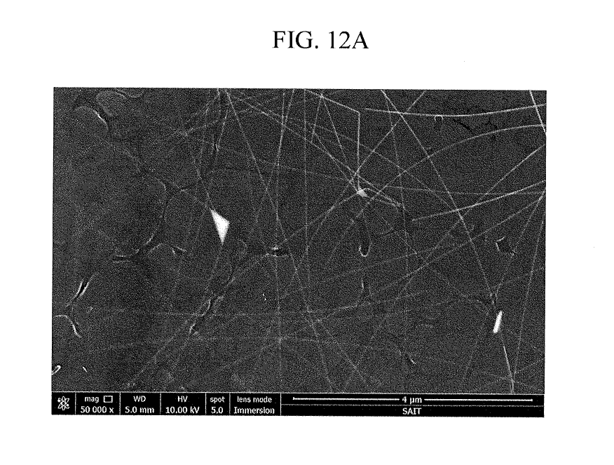

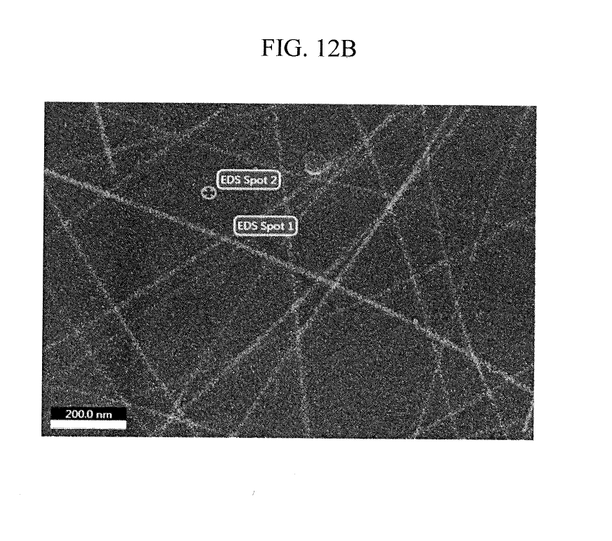

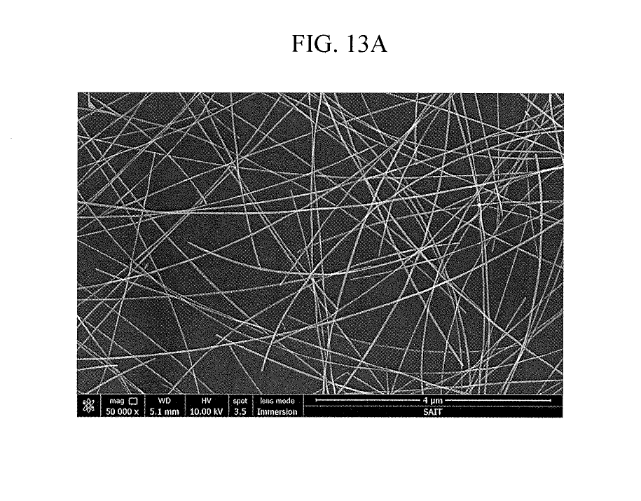

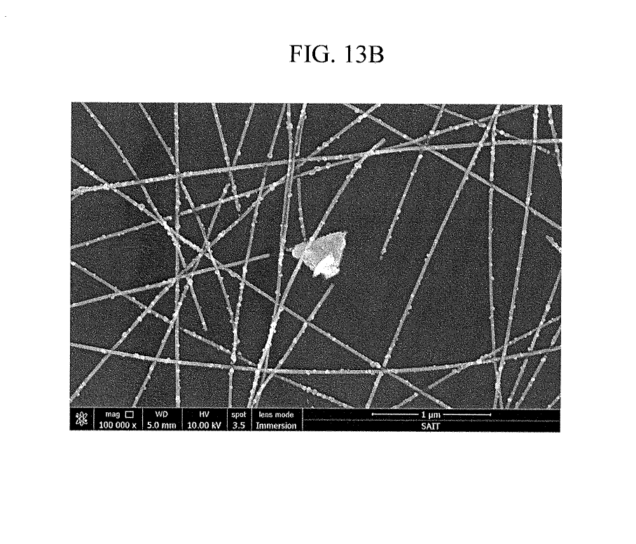

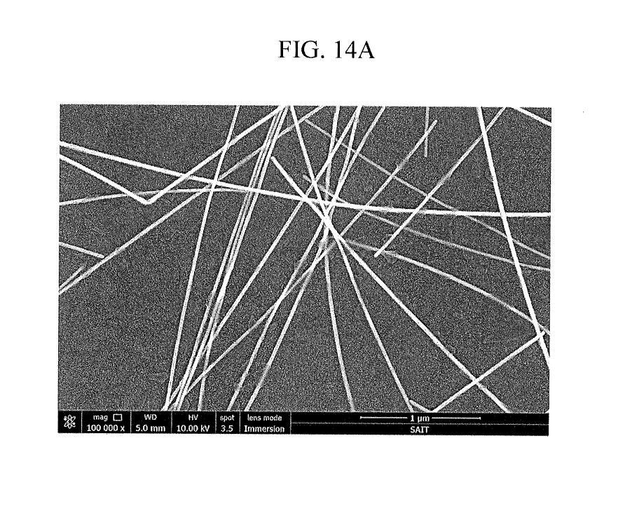

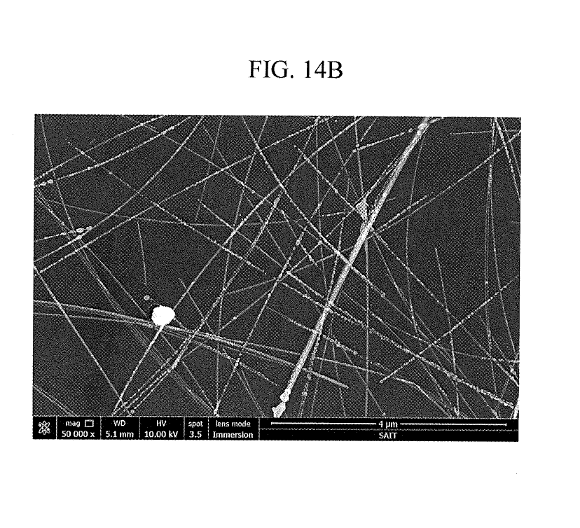

FIGS. 11A and 11B are SEM photographs of the conductive complex according to Example 1 before and after being exposed to air for 30 days, respectively, FIGS. 12A and 12B are SEM photographs of the conductive complex according to Example 2 before being exposed to air and after being exposed to air for 30 days, respectively, FIGS. 13A and 13B are SEM photographs of the conductive complex according to Comparative Example 1 before being exposed to air and after being exposed to air for 30 days, respectively, and FIGS. 14A and 14B are each comparative SEM photographs of the conductive complex according to Example 2 before and after being exposed to air for 30 days, respectively.

Referring to FIGS. 11A to 14B, each conductive complex according to Examples 1 and 2 is exposed to air for 30 days and shows not much silver nanowire change after the exposure to air, while each conductive complex according to Comparative Examples 1 and 2 shows many aggregates such as dots on the surface of the silver nanowire after the exposure to air for 30 days. The agglomerates turn out to be produced when the silver nanowire adsorbs oxygen, sulfur, and/or water.

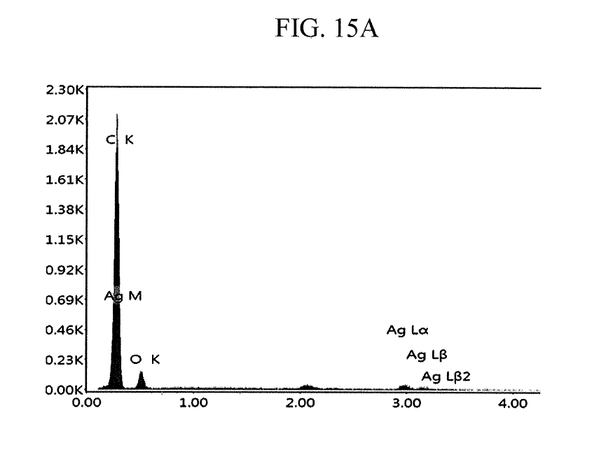

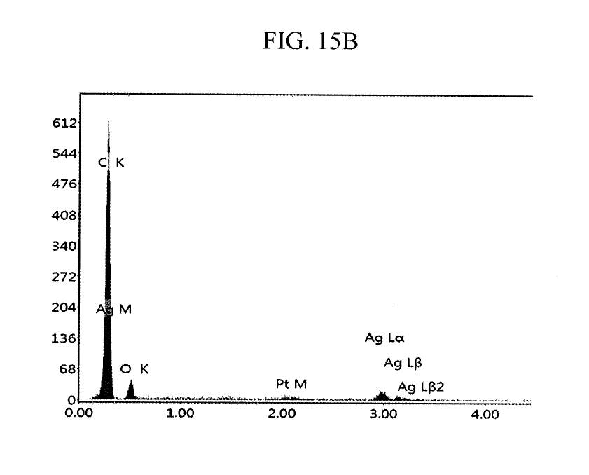

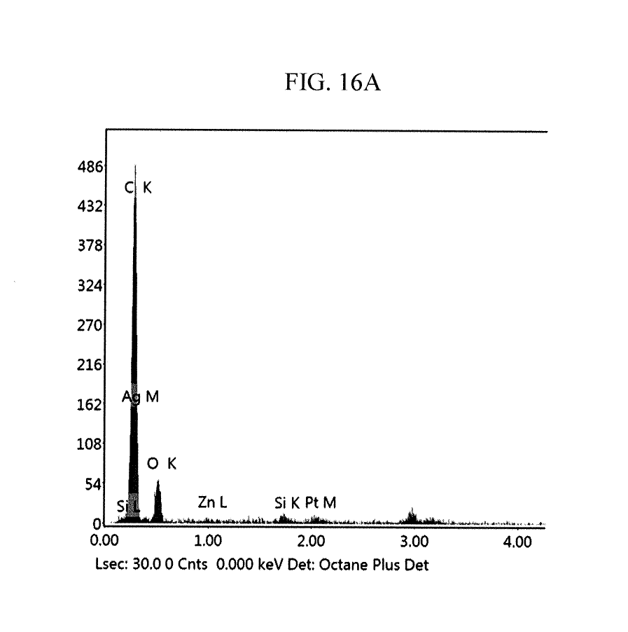

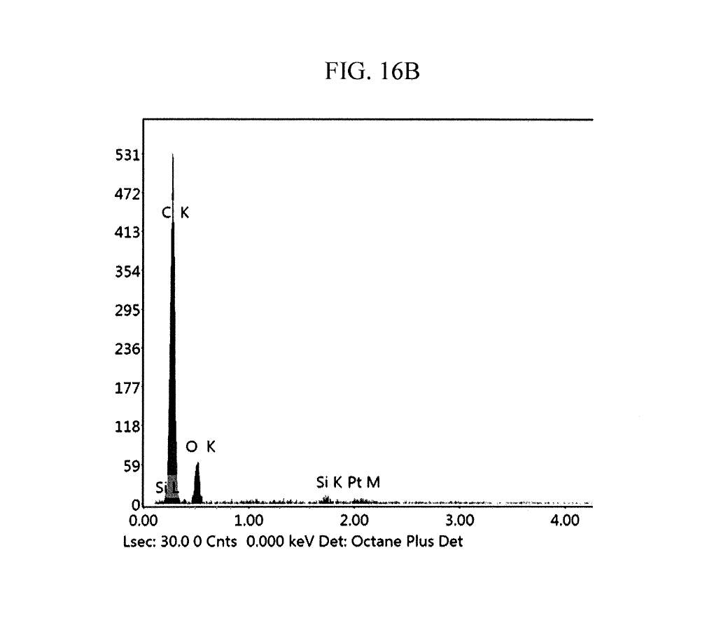

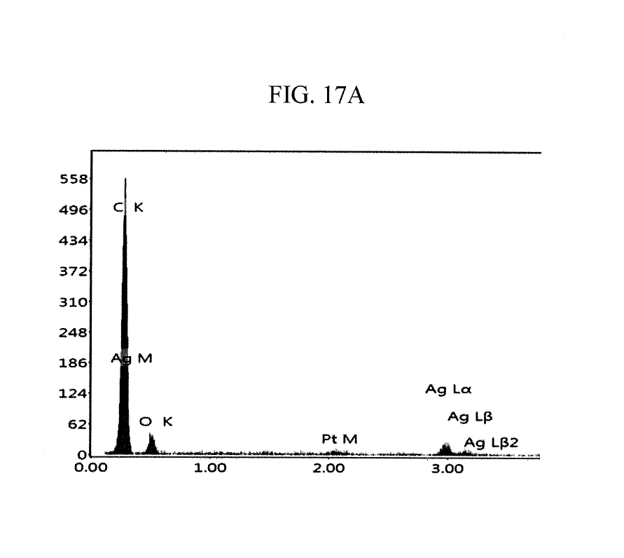

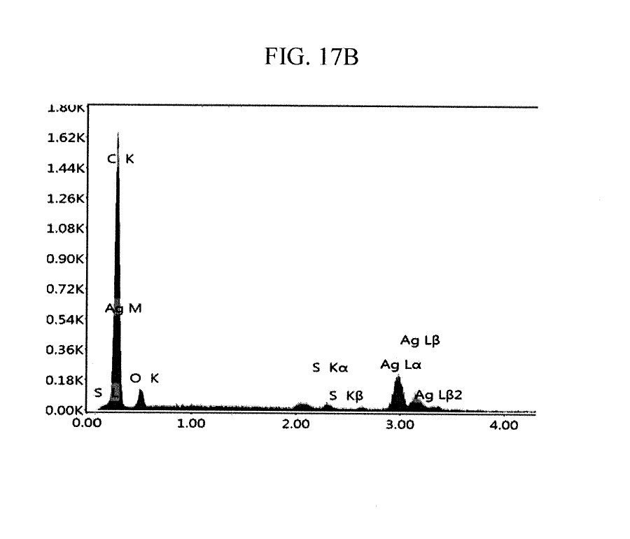

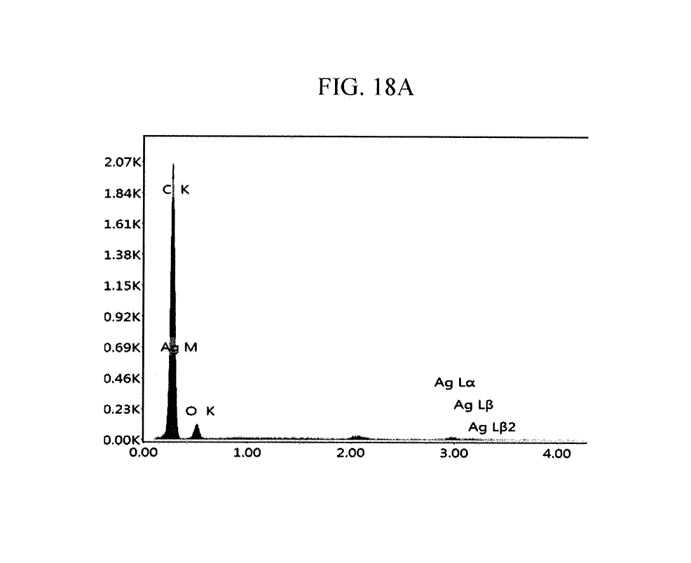

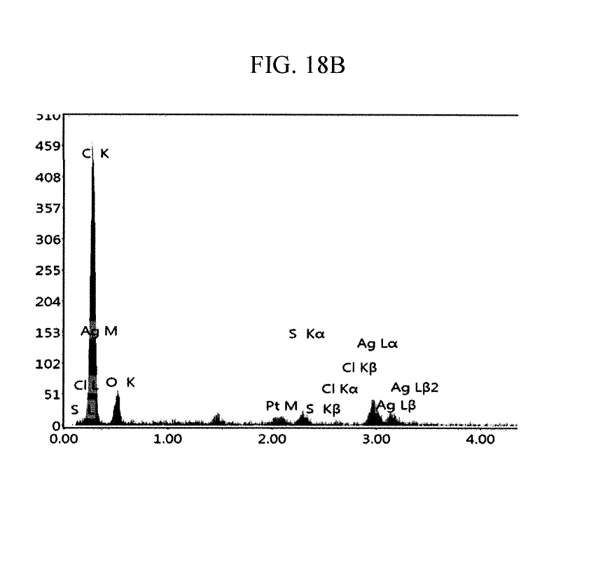

FIG. 15A shows surface atomic analysis results of the conductive complex according to Example 1, FIG. 15B shows surface atomic analysis results of the conductive complex according to Example 1 after being exposed to air for 30 days, FIG. 16A shows surface atomic analysis results of the conductive complex according to Example 2, FIG. 16B shows surface atomic analysis results of the conductive complex according to Example 2 after being exposed to air for 30 days, FIG. 17A shows surface atomic analysis results of the conductive complex according to Comparative Example 1, FIG. 17B shows surface atomic analysis results of the conductive complex according to Comparative Example 1 after being exposed to air for 30 days, FIG. 18A shows surface atomic analysis results of the conductive complex according to Comparative Example 2, and FIG. 18B shows surface atomic analysis results of the conductive complex according to Comparative Example 2 after being exposed to air for 30 days.

Comparing FIG. 15A with FIG. 15B, the conductive complex according to Example 1 shows almost no surface atomic change before and after the exposure to air for 30 days. Likewise, comparing FIG. 16A with FIG. 16B, the conductive complex according to Example 2 shows almost no surface atomic change before and after the exposure to air for 30 days.

On the contrary, comparing FIG. 17A with FIG. 17B, the conductive complex according to Comparative Example 1 shows a large surface atomic change before and after the exposure to air for 30 days. Likewise, comparing FIG. 18A with FIG. 18B, the conductive complex according to Comparative Example 2 shows a large surface atomic change before and after the exposure to air for 30 days.

Accordingly, the conductive complexes according to Examples 1 and 2 show higher chemical stability than the conductive complexes according to Comparative Examples 1 and 2.

### Evaluation 3: Electrical Characteristic Change Depending Over Time

Electrical characteristics of the conductive complexes according to Examples 1 and 2 and Comparative Examples 1 and 2 over time are evaluated.

The electrical characteristics are evaluated based on sheet resistance changes of the conductive complexes according to Examples 1 and 2 and Comparative Examples 1 and 2 before and after their exposure to air for 30 days. The sheet resistance is measured using a 4-probe method (Loresta GP, Mitsubishi Chemical, Japan).

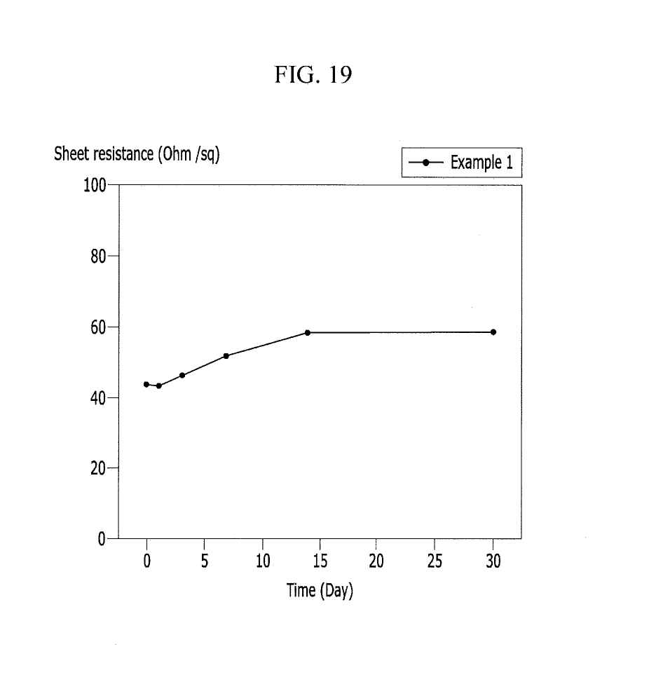

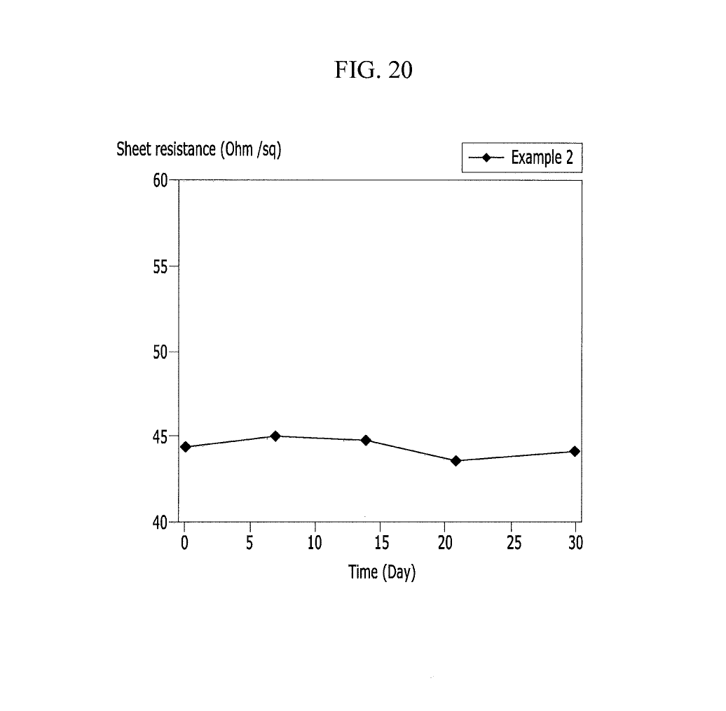

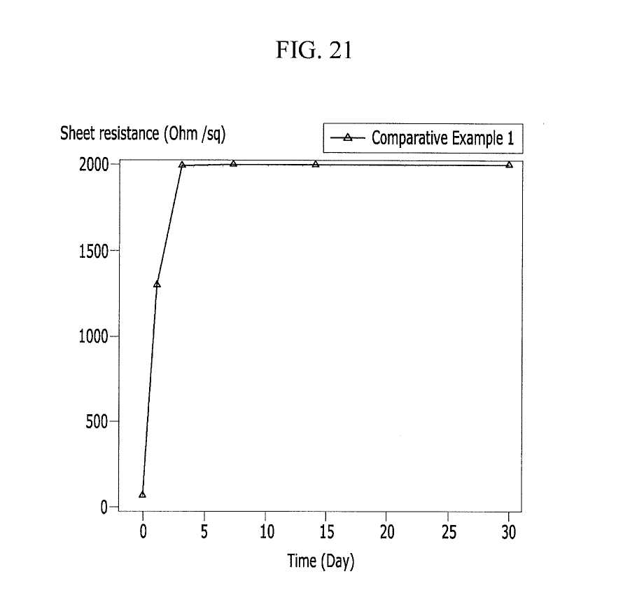

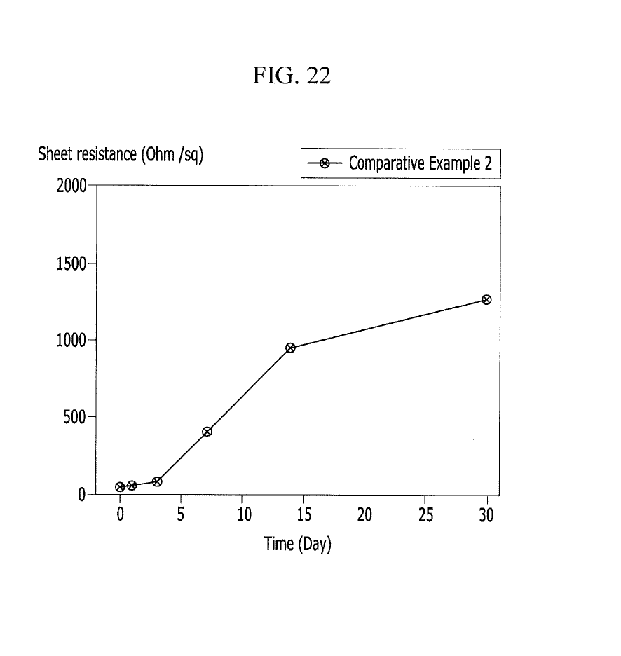

FIG. 19 is a graph showing sheet resistance change of the conductive complex according to Example 1 over time, FIG. 20 is a graph showing sheet resistance change of the conductive complex according to Example 2 over time, FIG. 21 is a graph showing sheet resistance change of the conductive complex according to Comparative Example 1 over time, and FIG. 22 is a graph showing sheet resistance change of the conductive complex according to Comparative Example 2 over time.

Referring to FIGS. 19 and 20, the conductive complexes according to Examples 1 and 2 show not much sheet resistance changes after exposure to air for 30 days, but have a sheet resistance variation ratio of less than or equal to about 10%. On the contrary, referring to FIGS. 21 and 22, the conductive complexes according to Comparative Examples 1 and 2 show sharply increased sheet resistance after the exposure to air for 30 days.

### Evaluation 4: Optical Property Change Depending Over Time

Optical properties of the conductive complexes according to Examples 1 and 2 over time are evaluated.

The optical properties are evaluated based on light transmittance and haze changes before and after the exposure of the conductive complexes according to Examples 1 and 2 to air for 30 days.

The light transmittance is measured by using a Varian Carry 5000 UV-visible spectrophotometer, and the haze is measured by using an NDH 5000 haze meter (Nippon Denshoku Industries Co. Ltd.).

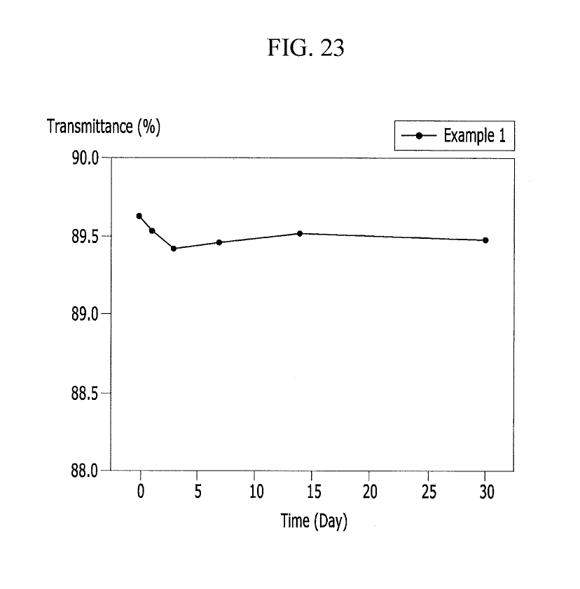

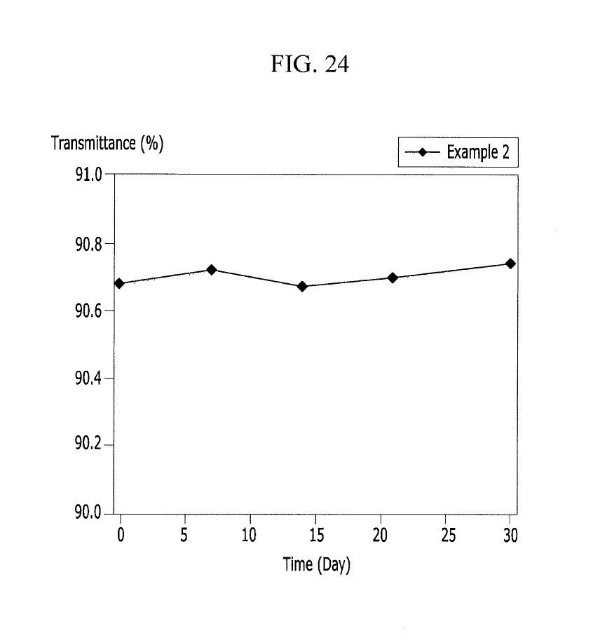

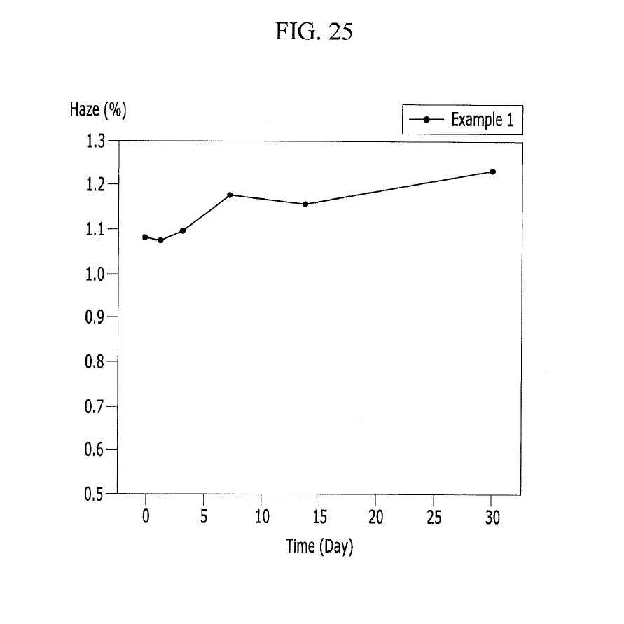

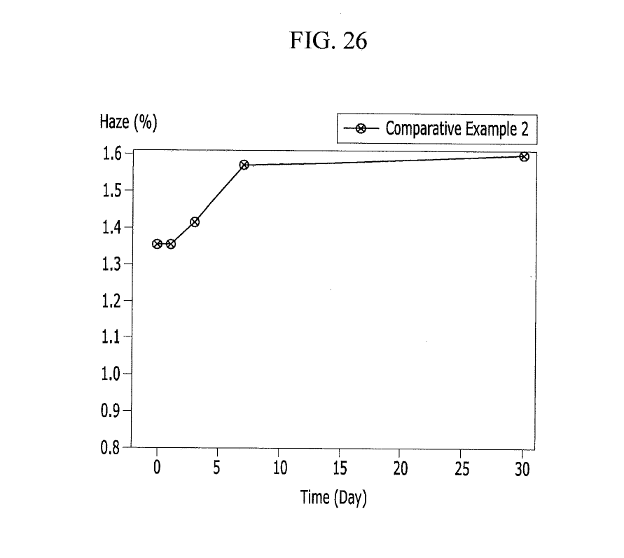

FIG. 23 is a graph showing light transmittance change of the conductive complex according to Example 1 over time, FIG. 24 is a graph showing light transmittance change of the conductive complex according to Example 2 over time, FIG. 25 is a graph showing haze change of the conductive complex according to Example 1 over time, and FIG. 26 is a graph showing haze change of the conductive complex according to Comparative Example 2 over time.

Referring to FIGS. 23 and 24, the conductive complexes according to Examples 1 and 2 show no large light transmittance changes after the exposure to air for 30 days and a light transmittance variation ratio of less than or equal to about 10%.

Referring to FIGS. 25 and 26, the conductive complex according to Example 1 shows a haze variation ratio of less than or equal to about 10%, while the conductive complex according to Comparative Example 2 shows a haze variation ratio of greater than or equal to about 20%.

### Evaluation 5: Optical Property Change Depending on Surface Coverage

Optical properties of the conductive complex according to Example 1 are evaluated depending on its surface coverage.

The surface coverage is calculated by using an area covered with a nanosheet relative to the entire area through an image obtained with a microscope and a surface analyzer. The optical properties are evaluated by measuring light transmittance depending on a surface coverage when the conductive complex according to Example 1 is exposed to air for 0 days, 14 days, and 30 days.

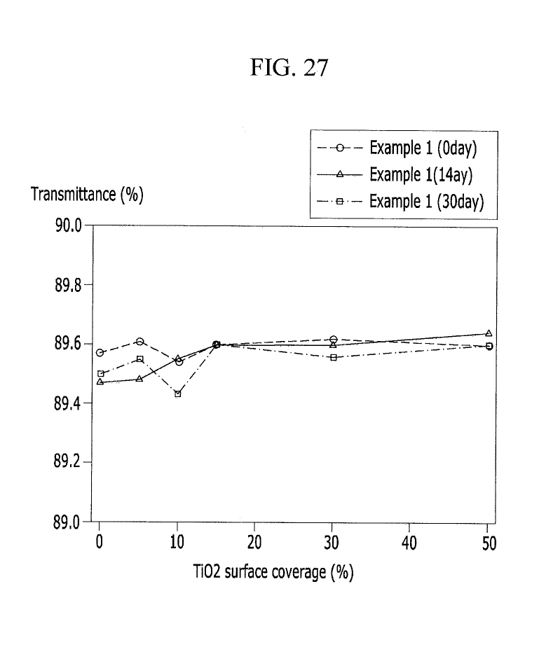

FIG. 27 is a graph showing light transmittance depending on surface coverage of the TiO₂ nanosheet of the conductive complex according to Example 1.

Referring to FIG. 27, the conductive complex according to Example 1 shows stable light transmittance regardless of time lapse when the TiO₂ nanosheet has a surface coverage of greater than or equal to about 15%.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A conductive complex comprising:
a conductive nanobody network comprising a plurality of conductive nanobodies randomly arranged; and
an overcoat layer comprising one-dimensionally or two-dimensionally shaped non-conductive nanobodies covering at least a portion of the conductive nanobody network.

2. The conductive complex of claim 1, wherein the non-conductive nanobodies comprise a nanosheet, a nanoflake, or a combination thereof.

3. The conductive complex of claim 2, wherein the non-conductive nanobodies comprise an oxide nanosheet, an oxide nanoflake, or a combination thereof.

4. The conductive complex of claim 1, wherein the non-conductive nanobodies comprise a semiconductor or insulation material having an energy band gap of about 2.5 eV or more.

5. The conductive complex of claim 1, wherein the non-conductive nanobodies comprise titanium oxide, zinc oxide, aluminum oxide, zirconium oxide, yttrium oxide, chromium oxide, tin oxide, lead oxide, hafnium oxide, hafnium silicate, lanthanum oxide, lanthanum aluminate, lead titanate, tantalum oxide, gallium oxide, gadolinium oxide, tungsten oxide, strontium titanate, barium titanate, iron titanate, potassium titanate, manganese titanate, bismuth oxide, silicon nitride, zinc sulfide, magnesium selenide, magnesium telluride, aluminum nitride, gallium nitride, an alloy thereof, or a combination thereof.

6. The conductive complex of claim 1, wherein at least a two non-conductive nanobodies positioned to be adjacent to each other have an overlapping portion.

7. The conductive complex of claim 1, wherein the conductive nanobody network and the overcoat layer are adjacent to each other.

8. The conductive complex of claim 1, wherein the conductive nanobodies comprise a nanowire, a nanotube, a nanoparticle, a nanocapsule, a nanosheet, a nanoplate, a nanocube, a nanosphere, a metal mesh, a metal nano thin film, a metal flake, graphene, or a combination thereof.

9. The conductive complex of claim 1, wherein the conductive nanobodies are one-dimensionally shaped nanobodies, and
the non-conductive nanobodies are two-dimensionally shaped nanobodies.

10. The conductive complex of claim 1, wherein the conductive nanobody network covered by the non-conductive nanobodies have a surface coverage of greater than or equal to about 15%.

11. The conductive complex of claim 1, wherein the conductive complex has both a sheet resistance of less than or equal to about 1000 ohms per square and a light transmittance of greater than or equal to about 70%.

12. The conductive complex of claim 1, wherein the conductive complex has a sheet resistance variation ratio, a haze variation ratio, and a light transmittance variation ratio of less than or equal to about 15% after being allowed to stand for 30 days at room temperature.

13. The conductive complex of claim 1, further comprising a substrate, wherein the conductive nanobody network is disposed on the substrate.

14. A method of manufacturing a conductive complex, comprising:
applying a conductive ink comprising a plurality of conductive nanobodies to form a conductive nanobody network; and
applying a non-conductive ink comprising zero-dimensionally, one-dimensionally or two-dimensionally shaped non-conductive nanobodies on the conductive nanobody network to form an overcoat layer.

15. The method of claim 14, wherein the non-conductive nanobodies comprise a nanosheet, a nanoflake, or a combination thereof.

16. The method of claim 14, wherein the non-conductive nanobodies comprise a semiconductor or insulation material having an energy band gap of about 2.5 eV or more.

17. The method of claim 16, wherein the non-conductive nanobodies comprise titanium oxide, zinc oxide, aluminum oxide, zirconium oxide, yttrium oxide, chromium oxide, tin oxide, lead oxide, hafnium oxide, hafnium silicate, lanthanum oxide, lanthanum aluminate, lead titanate, tantalum oxide, gallium oxide, gadolinium oxide, tungsten oxide, strontium titanate, barium titanate, iron titanate, potassium titanate, manganese titanate, bismuth oxide, silicon nitride, zinc sulfide, magnesium selenide, magnesium telluride, aluminum nitride, gallium nitride, an alloy thereof, or a combination thereof.

18. The method of claim 14, wherein the conductive nanobodies are one-dimensionally shaped nanobodies, and
the non-conductive nanobodies are two-dimensionally shaped nanobodies.

19. An electronic device comprising the conductive complex of claim 1.

20. The electronic device of claim 19, wherein the electronic device is a liquid crystal display, an organic light emitting diode display, a touch screen panel, a solar cell, a photoelectronic device, or a sensor.
